(19) United States
(12) Patent Application Publication
(10) Pub. No.: US 2026/0225104 A1
(43) Pub. Date: Aug. 6, 2026

(54) HEATING DEVICE

(71) Applicant: Regents of the University of Minnesota, Minneapolis, MN (US)

(72) Inventors: Tianhong Cui, Vadnais Heights, MN (US); Terrence William Simon, Saint Paul, MN (US); Yang Wang, Beijing (CN); Khoi Hoang Thien Nguyen, Minneapolis, MN (US); Peng Zhou, Minneapolis, MN (US); Yingming Xu, Minneapolis, MN (US)

(21) Appl. No.: 19/157,242

(22) PCT Filed: Feb. 16, 2024
(86) PCT No.: PCT/US24/16150

§ 371 Date: Aug. 15, 2025

Related U.S. Application Data
(60) Provisional application No. 63/485,724, filed on Feb. 17, 2023.

(51) Int. Cl. B01L 7/00; B01L 3/00; B23K 26/352; B23K 103/00; G05D 23/19; H05B 1/02; H05B 3/34

(52) U.S. Cl. CPC B01L 7/52; B01L 3/502715; B23K 26/352; G05D 23/1917; H05B 1/0244; H05B 3/34; B01L 2200/027; B01L 2200/12; B01L 2200/147; B01L 2300/0825; B01L 2300/12; B01L 2300/1805; B23K 2103/42; H05B 2203/017; H05B 2214/04

(57) ABSTRACT

Systems, devices, and techniques are configured to generate heat using a laser induced graphene heater. In one examples, a. heating device includes a substrate; a laser induced graphene layer disposed on the substrate; and an electrically conductive layer disposed in contact with the laser induced graphene later, wherein the electrically conductive layer is configured to be coupled to a power source.

This application is a PCT application claiming the benefit of and priority to U.S. Provisional Patent Application No. 63/485,724, filed Feb. 17, 2023, the entire contents of which is incorporated herein by reference.

### TECHNICAL FIELD

This disclosure generally relates to heating devices, and, more particularly, to devices configured to convert electrical energy to thermal energy.

### BACKGROUND

Heating devices are used for a variety of technologies. Some heating devices are resistive heating devices that convert electrical energy to thermal energy. Some laboratory techniques utilize heating devices, such as polymerase chain reaction (PCR) based techniques. In some examples, infectious diseases, such as COVID-19, can be detected from a patient sample using PCR based techniques. These PCR-based techniques employ cycles heating to amplify the amount of nucleic acid present in the given sample which can improve detection accuracy.

### SUMMARY

Techniques, systems, and device configured for generating heat using a graphene-based heating element. A graphene heating element may be utilized as a resistive heating element that converts current to heat. For example, a carbon dioxide (CO2) laser may be applied to a material, such as polyimide, to create a laser induced graphene layer. Electric current can be applied across the laser induced graphene layer to generate heat. The laser induced graphene layer can be a part of a graphene heater that can be leveraged for a variety of heating purposes. Example systems that may employ such a graphene heating element may include laboratory systems, such as PCR devices, or other systems requiring heating elements capable of delivering repeatable and efficient heating. In some examples, the graphene heating element may be part of an on-chip heating system that includes the graphene heating element on a substrate, with a layer of curing glue forming a microfluidic channel over the graphene heating element and a top layer of glass on the glue to enclose the microfluidic channel. A sample of fluid can then be flowed through the microfluidic channel and heated as needed by the graphene heating element, such as to perform loop-mediated isothermal amplification (LAMP).

In one example, a heating device includes a substrate; a laser induced graphene layer disposed on the substrate; and an electrically conductive layer disposed in contact with the laser induced graphene later, wherein the electrically conductive layer is configured to be coupled to a power source.

In one example, a method of manufacturing a laser induced graphene heater includes applying polyimide to a substrate; directing laser energy to the polyimide to generate a laser induced graphene layer in the polyimide on the substrate; and applying an electrically conductive layer in contact with the laser induced graphene layer, wherein the electrically conductive layer is configured to be coupled to a power source.

In one example, an on-chip diagnostic system includes a substrate; a laser induced graphene layer disposed on the substrate; a middle layer on the substrate, the middle layer forming a central void over at least a portion of the laser induced graphene layer; and a top layer over the middle layer, wherein the substrate, the middle layer, and the top layer defines a microfluidic channel comprising the central void.

In one example, a diagnostic system includes a first housing portion defining: an injection port; a first chamber configured to contain a first solution; a second chamber configured to contain a second solution; a second housing portion defining at least one waste chamber configured to receive fluid from at least one of the first chamber or the second chamber; a graphene heating element carried on the second housing portion, wherein the graphene heating element comprises a laser induced graphene layer and an electrically conductive layer in contact with the laser induced graphene layer, wherein the electrically conductive layer is configured to be coupled to a power source; and a sliding panel comprising a sample chamber configured to contain a biological sample, wherein the sliding panel is: positioned between the first housing portion and the second housing portion; and configured to move the sample chamber to different positions corresponding to at least the first chamber and the second chamber of the first housing portion.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a conceptual diagram illustrating an example medical diagnostic device as described herein.

FIG. 1B is an exploded view of the example medical diagnostic device of FIG. 1A.

FIG. 1C is a conceptual view of a sample applied to filter paper in an injection port.

FIG. 1D is a cross-sectional view of the example medical diagnostic device of FIG. 1A.

FIG. 2A is a cross-sectional view of the example medical diagnostic device of FIG. 1A.

FIG. 2B is a conceptual diagram of a laser-induced generation of a graphene heating element.

FIG. 2C is a graph of an example PCR process executed by the example medical diagnostic device of FIG. IA.

FIG. 3 is a diagram of an example amplification process for DNA in a sample.

FIG. 4 is a flow chart illustrating a technique for LAMP-LFA amplification of DNA in a sample.

FIG. 5 is a diagram of a multistep process of using the example medical diagnostic device of FIG. 2A.

FIG. 6 is a graph of example heating cycles using a heating element.

FIG. 7A is a graph of example heating and cooling using a graphene heating element.

FIG. 7B is a graph of example heating and cooling cycles using a graphene heating element.

FIG. 8 is a flow diagram illustrating an example technique for operating a medical diagnostic device as described herein.

FIGS. 9A and 9B are conceptual illustrations of a graphene heating element.

FIGS. 10A and 10B are an exploded view and cross-sectional view of an example graphene heating element and example chamber to be heated.

FIG. 11 includes different magnification images of a laser induced graphene layer for a heating element.

FIG. 12A is a graph of temperate for different input power for a laser induced graphene heating element.

FIG. 12B is a graph of temperate for different input power for a graphene ink heating element.

FIGS. 13 and 14 are graphs of temperature over time for an example graphene heating element.

FIGS. 15A and 15B are graphs of temperature and power over time for a graphene heating element cycling temperature for one-minute PCR cycles.

FIGS. 16A and 16B are graphs of temperature and power over time for a graphene heating element during cycling.

FIG. 17 is an example process for manufacturing a laser induced graphene heater as described herein.

FIG. 18A is an exploded view of an example medical diagnostic device that includes a heating element as described herein.

FIG. 18B is a perspective view of an example medical diagnostic device of FIG. 18A.

FIG. 19 is an illustration of example test strips for different samples using the medical diagnostic device of FIGS. 18A and 18B.

### DETAILED DESCRIPTION

In general, the disclosure describes systems, devices, and techniques for generating heat using electrical power applied to a heating device.

Heating devices can use a variety of different materials that can generate heat using electrical power. Some heating devices may use resistive heating that converts electrical current through the heating element to heat. Various metals or metal alloys can be used as the resistive heating element, depending on the desired performance of the heating element. However, some resistive beating elements can require relatively high power to generate desired heat. Higher power requirements can limit the portability of certain heating devices. Some resistive heating elements can retain heat and cool slowly, which can increase heating cycles for various applications. In some examples, metal or metal alloy heating elements can be relatively expensive. For example, for a disposable device, metal or metal alloy heating elements may not be financially feasible.

As described herein, laser induced graphene heating elements can convert electrical energy to thermal energy for a variety of different purposes and use cases. A laser induced graphene heating element can efficiently convert electrical power, which may reduce the input power needed to achieve desired temperatures of the heating devices. Laser induced graphene heating elements may also be efficient at transferring heat to increase cooling and reduce the time needed to operate heating cycles. In addition, laser induced graphene heating elements may be relatively inexpensive to produce. These advantages may be beneficial for various applications such as disposable devices and/or portable devices that may not have access to line electrical power.

One example use of a laser induced graphene heater may be in a PCR device that needs to generate several heating and cooling cycles to amplify DNA in a sample. For example, rapid and accurate detection of infectious diseases on-site, such as COVID-19, is of great importance to both treatments and pandemic management. However, in resource-limited or at-home settings, conventional medical devices face obstacles such as interrupted power supplies, a shortage of skilled professionals, sophisticated infrastructures, and high-cost. In such circumstances, clinical decisions are based on symptoms rather than diagnostic tests, leading to complex clinical complications.

In terms of the detection mechanisms, the point-of-care testing (POCT) devices can be divided into two categories: immunoassay-based methods for detection of antigens (structural surface proteins or antibodies) and nucleic acid testing (NAT) methods for direct determination of infectious pathogens (DNA/RNA, genetic materials). Presently, lateral flow assay (LFA) is a kind of user-friendly, cheap, and easily mass-produced POCT device for detection of antigens of infectious pathogens (such as COVID-19) based on immunoaffinity reaction.

LFA-based products are available. However, without any signal amplification, traditional colloidal gold based LFA is limited to relatively low sensitivity and incapable of quantification measurement. Moreover, in real clinical settings, low virus loads have been frequently observed in some patients, leading to low concentration of antigens, which ultimately leads to false-negative results when using LFA. The accuracy of LFA is declared to be about 90%.

In contrast, nucleic acid testing (NAT) methods can directly identify the specific sequences of the genetic materials of infectious and then amplify the origin concentration to a level of 10 billion ~1 trillion. With the specific identification and amplification process, the NAT methods possess a significantly higher sensitivity and specificity than LFA, with a detection accuracy up to 98%. Among the NAT methods, reverse transcription polymerase chain reaction (RT-PCR) is the considered as the gold-standard. Although with high sensitivity and accuracy, it is typically a laboratory-based, rather than home-based detection method due to the reliance on sophisticated infrastructures and trained operators.

Unlike PCR-based methods, isothermal amplification techniques, which are conducted at fixed temperature, do not rely on the expensive instruments for thermal cycling, thus offering the convenience and potential option home-based testing. Such as loop-mediated isothermal amplification (LAMP), it is a low-cost yet rapid isothermal approach, which enables the identification of the target nucleic acid fragment of infectious pathogens within 40 min, by using a set of primers and a strand-displacement polymerase at a constant temperature (60-65° C.). Moreover, there are a lot of different ways to directly visualize a LAMP reaction product. Thus, it would be beneficial to develop integrated while affordable, sensitive, specific, user-friendly, rapid and robust, equipment-free, and deliverable (ASSURED) platforms based on isothermal amplification methods. In particular, the development of a ASSURED NAT device is a great challenge because many steps, including cell or virus lysis, nucleic acid extraction and enrichment, and nucleic acid amplification or detection signal amplification, must be accomplished in a portable while low-cost device.

In one use case for a heating element, a medical diagnostic device can be used to detect biological substances, such as nucleic acids, without the disadvantages of expensive equipment or reduced detection. For example, an example medical diagnostic device described herein can be ultra-sensitive, accurate, low-cost, easy-to-use, and a fast platform for diagnostics of SARS-CoV-2 antigen. In some examples, the diagnostic device have one or more of the following attributes: 1) embedded loop-mediated Isothermal amplification (LAMP), 2) integrated RNA extraction and lateral flow immunoassay with LAMP, 3) sample-in-answer-out (RNA extraction+isothermal amplification), 4) high sensitivity and accuracy (based on amplification), 5) easy operation (simple one-dimension pulling), 6) visual reading (results can be read directly by naked eyes), and/or 7) low cost (polymer and paper hybrid construction).

Rapid and accurate detection of infectious diseases on-site can enable timely isolation of infected cases and effective contact tracing of potential infected cases. This can provide both treatments and pandemic management. The medical diagnostic device described herein can be manufactured with a low cost, have easy operation, and high sensitivity and specificity for point-of-care detection of infectious diseases at-home or in remote areas. The device can be ultraportable: such as less than 100 grams in weight and smaller than 10 cm in length, less than 3 cm in height, and less than 3 cm in width in some examples. The device can then be a completely novel structure is designed and adopted to integrate full functions, including sample preparation, nucleic acid amplification, and final readouts in a single medical diagnostic device. The device can enable the entire detection process through simple stretching outwards along one direction with the fingers of a single user. The detection results can be read directly by naked eye. The device can also be of low-cost and easily affordable for home-based testing or remote-area testing. The low cost of the device can facilitate disposable attributes such that a new device can be used for each sample instead of sterilizing the same device for testing different samples. In some examples, the device can include three low-cost plastic layers (including but not limited to PMMA, polycarbonate, or any other polymer or composite) fabricated by laser-cutting. The device can eliminate the needs for any additional instruments when testing, further reducing the costs. The device can be versatile for testing different biological substances while highly sensitive and accurate.

As a detection platform, it can be integrated with different kinds of isothermal amplification methods (including but not limited to LAMP, recombinase polymerase amplification (RPA), with a limit of detection (LOD) up to 1,000 copies/mL and a detection accuracy up to 98%. Compared with traditional lateral flow immunoassay (LFA), the sensitivity is 1,000 to 10,000 times higher. Moreover, the device is not only suitable for detecting COVID-19, but also suitable for different types of pathogens and viruses from a variety of sample sources (blood, urine, saliva, swabs). A laser induced graphene heating element can achieve the desired thermal amplification methods.

In addition to low cost, the medical diagnostic device described herein can support portability for the entire testing process, from sample preparation to signal amplification to readouts without additional instruments. Moreover, the device enables easy-operation which realizes the entire detection process through simple stretching outwards along one direction with the user's fingers. The medical device proposed here is a kind of universal platform which is suitable for detection of different types of pathogens and viruses (such as COVID-19, Lyme diseases, Influenza, and Monkeypox) from a variety of sample sources (blood, urine, saliva, swabs).

In summary, an example medical diagnostic device integrates all functions from sample preparation, isothermal amplification using a laser induced graphene heating element, to final readouts with a relatively low cost. The device can provide numerous advantages over other alternatives, such as ease of operation, low cost, and increases sensitivity and accuracy. For ease of operation, the device integrates full functions, including sample preparation, nucleic acid amplification and final readouts in a single chip (e.g., the device). The chip realizes the entire detection process through simple stretching outwards along one direction with the user's fingers. The results can be read directly by naked eyes instead of requiring the use of specialized equipment. With regard to cost, the device can be constructed of common polymers (such as PMMA) using commonly used manufacturing techniques such as laser-cutting. No expensive instruments are required for operation or readout. As a detection platform, it can be integrated with different kinds of isothermal amplification methods (including but not limited to LAMP, RPA), with a LOD up to 102 copies/mL and a detection accuracy up to 98%. It is suitable for detection of different kinds of biological substances found in a variety of samples including blood, saliva, urine and swabs.

In some example, the medical diagnostic device can be referred to as an on-chip diagnostic system. The system can include a substrate and a laser induced graphene layer disposed on the substrate. The system can include a microfluidic channel that is defined by at least a middle layer on the substrate, the middle layer forming a central void over at least a portion of the laser induced graphene layer, and a top layer over the middle layer. The substrate, the middle layer, and the top layer defines a microfluidic channel that includes the central void. The middle layer may include a glue layer, and the top layer may be a glass slide that defines an inlet and outlet such that a sample can be injected through the inlet, through the microfluidic channel for heating by the graphene beating element on the substrate, and exited through the outlet in the top layer.

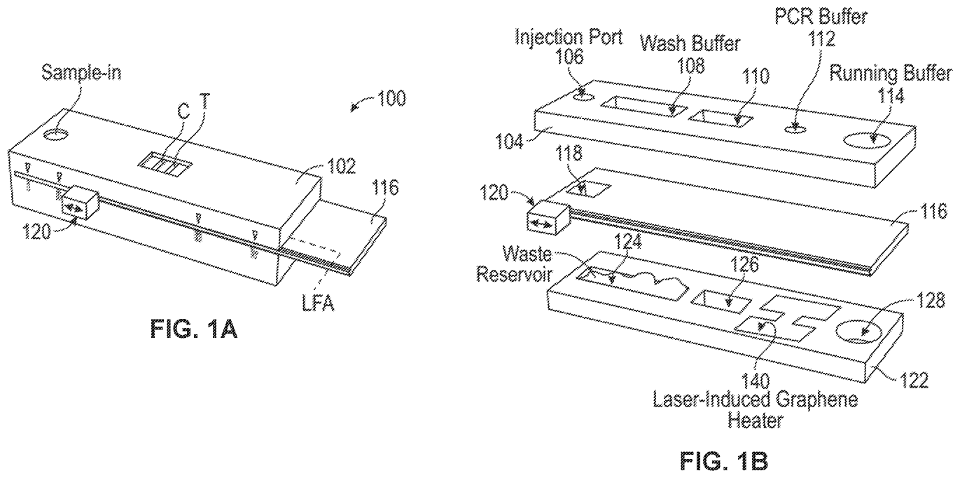

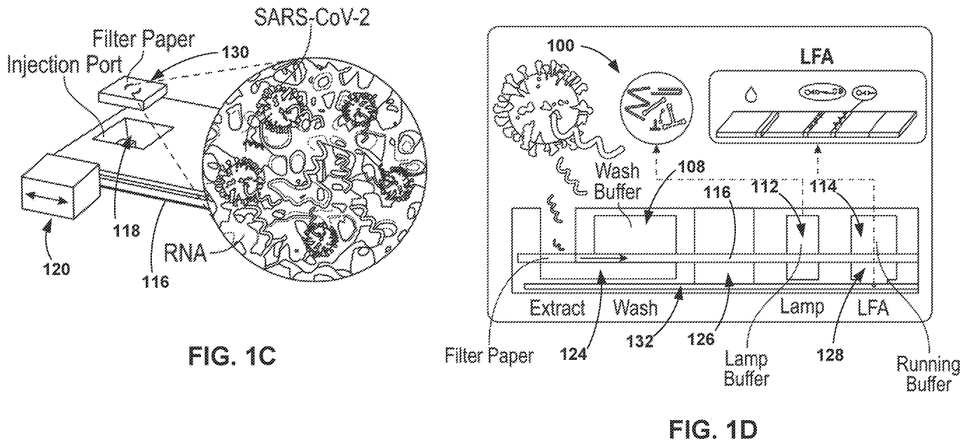

Although a laser induced graphene heater is described for the purposes of a medical diagnostic device, the laser induced graphene heater may be used in any number of different applications. Laser induced graphene heaters may be constructed and used in other diagnostic devices, electronic device temperature control, battery heating, clothing, food transport, food preparation, or any other use. Examiner applications that may benefit from a laser induced graphene heater may include those applications that have limited power or benefit from a low-cost disposable or temporary device. FIG. 1A is a conceptual diagram illustrating an example medical diagnostic device 100 that includes a graphene heating element. As shown in the example of FIG. IA, medical diagnostic device 100 includes cover 102 that defines a window through which the sample test paper can be viewed after the diagnostic process is complete. For example, the sample test paper may include a control and test portion to confirm that the process was successful. An oral swap, for example, can be placed through an opening in cover 102 so that the sample can be placed on the test paper within medical diagnostic device 100. The end of sliding panel 116 is shown sticking out the end of cover 100, and sliding panel 116 can be moved within cover 102 via knob 120 (e.g., a handle). The entirety of medical diagnostic device 100 can be shaped like a USB disk drive or other hand-held device. In some examples, medical diagnostic device 100 has a length less than about 10 cm, a width less than about 3 cm, and a height less than about 3 cm.

FIG. 1B is an exploded view of the example medical diagnostic device of FIG. 1A. As shown in the example of FIG. 1B, medical diagnostic device 100 includes three layers, such as first housing portion 104, sliding panel 116, and second housing portion 122. First housing portion 104 may be referred to as a top layer, sliding panel 116 may be referred to as a middle layer, and second housing portion 122 may be referred to as bottom layer 122. In some examples, the three layers may be constructed of PMMA and fabricated by laser-cutting, which is rather low-cost. The three layers are tightly integrated together. In some examples, one or more seals may be provided between the layers to prevent liquid from moving between the layers and migrating between different chambers.

First housing portion 104 may have a thickness of 4 mm in some examples. First housing portion 104 may define injection port 106 through which the sample can be placed. First housing portion 104 may also define one or more additional chambers that may include respective fluids, such as chamber 108, chamber 110, chamber 112, and chamber 114. One or more of these chambers may be pre-packaged with a specific fluid. In one example, chamber 108 may hold a washing buffer, chamber 112 may hold a LAMP buffer, and chamber 114 may hold a strip running buffer. Chamber 110 may hold another buffer or be left empty and used as a viewing window for the results of the test paper.

Sliding panel 116 may define knob 120 and sample chamber 118. In some examples, sliding panel 116 may have a thickness of about 3 mm. Sliding panel 116 may be used to load an FTA card (3*3 mm) to lyse the virus and then absorb nucleic acid of the sample. Sample chamber 118 may be configured to hold the FTA card or another test paper or sample paper that holds the sample and enables viewing of the results of the test. Liquid may pass through the paper and through sample chamber 118.

Second housing portion 122 may have a thickness of about 4 mm thick in some examples. Second housing portion 112 may define waste reservoir 124 which may have one or more chambers and/or a continuous chamber with apertures corresponding to the respective chambers of first housing portion 104. For example, a hole may correspond to the sample pad of the LFA below. Other waste chambers may include chamber 126 and 128.

LFA is used for the detection of isothermal amplicons, whose results can be read directly by naked eyes. Based on isothermal amplifications, the concentration of target nucleic acids can be amplified to a level of 106 to 1010 within 25-45 min. Isothermal amplification may be provided via an internal heating element, such as laser induced graphene heater 140. Laser induced graphene heater 140 may be powered by an internal power source (e.g., a battery) or an external power source (e.g., an AC output or via connection to another battery power source that could include a mobile computing device). The internal or external power source may include circuitry configured to control the power delivered to laser induced graphene beater 140 to achieve desired temperatures needed to complete amplification. Temperatures of laser induced graphene heater 140 may be indirectly estimated based on delivered current to laser induced graphene heater 140 or directly controlled via one or more temperature sensors that provide feedback to control the temperature of laser induced graphene heater 140. Laser induced graphene heater 140 is shows in the shape of an “H”, but any other shapes may be used, such as circles, ovals, rectangles, squares, triangles, etc. The shape of laser induced graphene heater 140 may be selected in order to achieve desired heating performance, such as heating speed and/or cooling speed. Although a single laser induced graphene heater 140 is shown, two or more laser induced graphene heating elements may be used in a single medical device 100. The two or more laser induced graphene heater elements may be powered by the same power source or separate power sources.

Compared to an individual LFA that directly detects antigens, the sensitivity of the device can be 103 to 104 times higher. A result-reading window 110 is designed on the middle of the device at the corresponding detection line and control line of the LFA for easy reading.

Once the amplification amplicons are loaded with running buffer into the sample pad of the LFA, the final results can be read directly from the chamber or window 110. In this manner, medical diagnostic device 100 can be preloaded with all solutions or reagents needed for the diagnostic process. The user can manually add the sample into the injection port 106 to the sample paper and move the sample through the different chambers of medical diagnostic device 100 until the results are available. As shown in FIG. 1A, case 102 may include markings on the outside of the device that show each position to move sliding panel 116 during the diagnostic process. When time is important at each stage, the user may follow a timer or follow instructions via a software application operating on a computing device, such as a smartphone or handheld computer.

In this manner, medical diagnostic device 100 may be a diagnostic system that includes a first housing portion defining an injection port, a first chamber configured to contain a first solution, a second chamber configured to contain a second solution, a second housing portion defining at least one waste chamber configured to receive fluid from at least one of the first chamber or the second chamber. The device may also include a sliding panel comprising a sample chamber configured to contain a biological sample, wherein the sliding panel is positioned between the first housing portion and the second housing portion and configured to move the sample chamber to different positions corresponding to at least the first chamber and the second chamber of the first housing portion. Cover 102 may enclose at least a portion of the first housing portion, the sliding panel, and the second housing portion.

In some examples, at least a first fluid seal is provided between the first housing portion and the sliding panel and at least a second fluid seal between the second housing portion and the sliding panel. The waste chamber, or reservoir, may be a single chamber or include separate respective chambers for each of the first chamber and the second chamber. Waste reservoir 124, alone or in combination with other chambers such as chambers 126 and 128, may accept excess fluid that falls from the respective chamber in first housing portion 104 when sample chamber 118 is moved between a chamber containing the fluid or solution and the below waste reservoir. In this manner, the solution is applied to the test paper and excess solution passes through to the waste reservoir.

First housing portion 104 may include viewing window 110 extending fully through first housing portion 104, wherein the sample associated with sliding panel 116 is exposed via viewing window 110 and the window in cover 102. The sample chamber 118 may include filter paper.

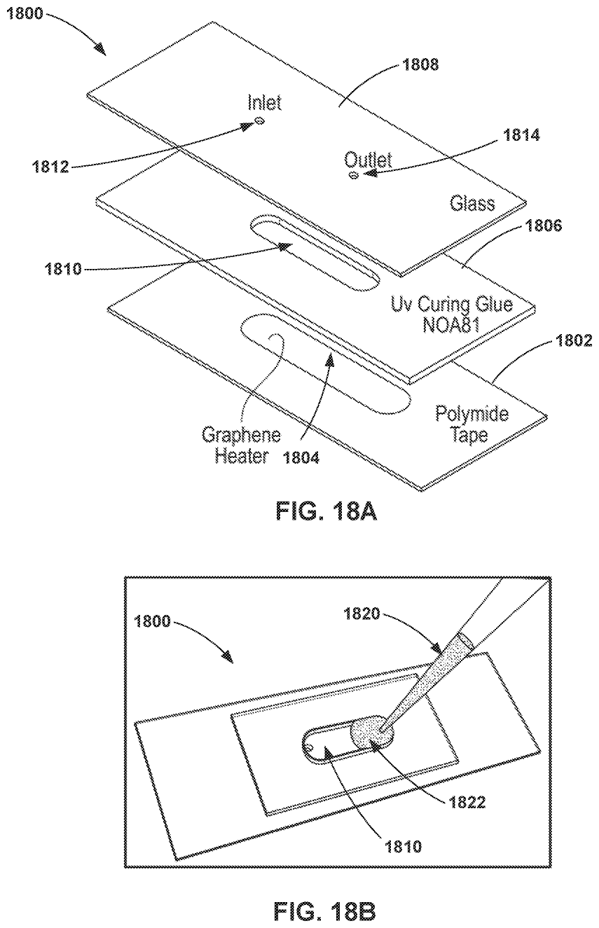

FIG. 1C is a conceptual view of a sample applied to filter paper 130 that would be placed within injection port 106 of medical diagnostic device 100. As shown in the example of FIG. 1C, filter paper 130 can be held within the sample chamber 118 of sliding plane 116. The sample may contain RNA from SARS-CoV-2 infected patients, as may be detected by medical diagnostic device 100, or another device such as medical diagnostic device 1800 of FIG. 18.

FIG. 1D is a cross-sectional view of the example medical diagnostic device 100 of FIG. 1A. In some examples, the DNA washing buffer (2*700 μL) in chamber 108, isothermal amplification reaction buffer (20 μL) in chamber 112, and running buffer (200 μL) in chamber 114 are pre-packaged into the corresponding liquid storage chambers (108, 112, and 114). As a result, potential liquid leakage is a concern. To prevent liquid leakage, 1H,1H,2H,2H-Perfluorooctyl Trichlorosilane, a kind of hydrophobic material, can be used for hydrophobic treatment of each layer of the chip (e.g., medical diagnostic device 100). Moreover, the viewing window 110 (in FIG. 1B) can be tightly sealed with one or more adhesive films. The waste reservoir 124 can be filled with cotton or other absorbing material to absorb the waste liquid. The entire chip of medical diagnostic device 100 can thus be manufactured in a sealed state, which can effectively prevent liquid leakage and aerosol pollution during detection. The DNA wash buffer used can be 10 mM Tris (pH=8). Isothermal amplification buffer can contain the primers and reaction mixture provided from the Loopamp® DNA Amplification kit. Running buffer is Tris-EDTA buffer.

In one example, during detection, 20 μL of raw sample (saliva/swabs/urine/blood) is directly added into the medical diagnostic device 200 via the injection port to reach the surface of FTA paper contained by the sample chamber of the sliding place. The FTA paper can be configured to provide solid-phase extraction function as it is a special filter paper soaked by strong denatured agent and chelating agent. In this manner, the virus will be lysed and the corresponding nucleic acids will be adsorbed onto the FTA paper. In the second step, the user can grab the knob of the sliding plane to slide the FTA card to the washing chambers to remove impurities and inhibitors on the surface of the FTA card. In the third step, the user can again pull the knob of the sliding plane to slide the FTA paper into the isothermal amplification chamber associated with the heating element, where the isothermal amplification reactions are completed by medical diagnostic device 200. In some examples, the reaction could be carried out under a constant temperature (e.g., 35-42° C. for RPA or 60-65° C. for LAMP). The temperature can be achieved by low-cost laser-induced graphene heater (e.g., an example heating element) through wired or wireless communications with a mobile computing device (e.g., a tablet computer or smartphone). In the final step, the user can again pull on the knob of the sliding plane to slide the FTA paper with the amplification products out to the chamber storing the running buffer. Along with the amplification products, the running buffer flows to the sample pad of the LFA, and a color reaction will be presented on the test line and control line of the FTA paper. The amplification results can be observed through the viewing window of medical diagnostic device 200 by naked eye of the user. After results are shown, medical diagnostic device 200 could be disposed of because it may be configured to be a single-user device for only a single sample.

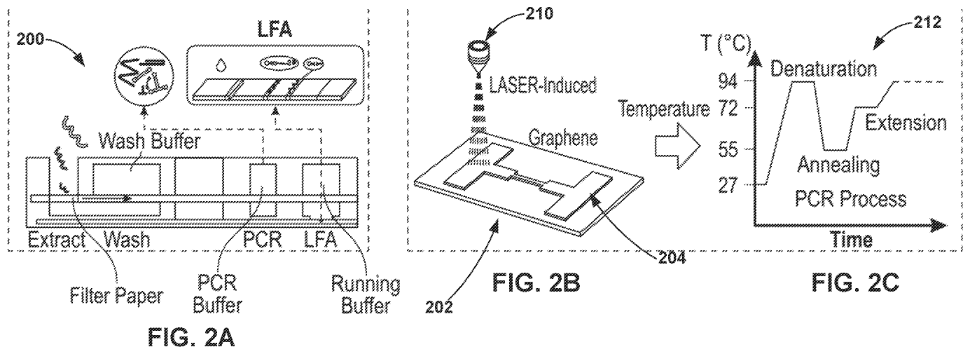

FIG. 2A is a cross-sectional view of the example medical diagnostic device 100 of FIG. 1A. FIG. 2B is a conceptual diagram of a laser-induced generation of a graphene heating element 202 that can be placed within medical diagnostic device 100, and may be similar to laser induced graphene heater 140. The laser-induced manufacturing process may include laser 210 that generates a graphene element 204 that can be heated with relatively small electrical current and increase and decrease temperatures relatively quickly as needed for the amplification process. The shape of the graphene heating element 204 (which is part of heating element 202) may be selected as needed for target temperatures and/or to improve heating and cooling times for each cycle.

In some examples, heating element 202 (or heating element 140) is shaped like an “H”, but other shapes are also contemplated, such as circles, ovals, triangles, squares, polygons, or other curved or amorphous shapes. In some examples, the shape of heating element 202 may correspond to the shape of sample chamber 118 to focus heating. Heating element 202 may be smaller than sample chamber 118 to focus heating to a certain location or larger than sample chamber 118.

FIG. 2C is a graph 212 of an example PCR process executed by the example medical diagnostic device 100 of FIG. IA. As shown in FIG. 2C, the heating element 202 may be controlled to increase and decrease temperatures at specific times in order to achieve different phases of the amplification process. This may include heating for denaturation, cooling for an annealing process, and then again heating for extension. Such a process may be repeated as needed.

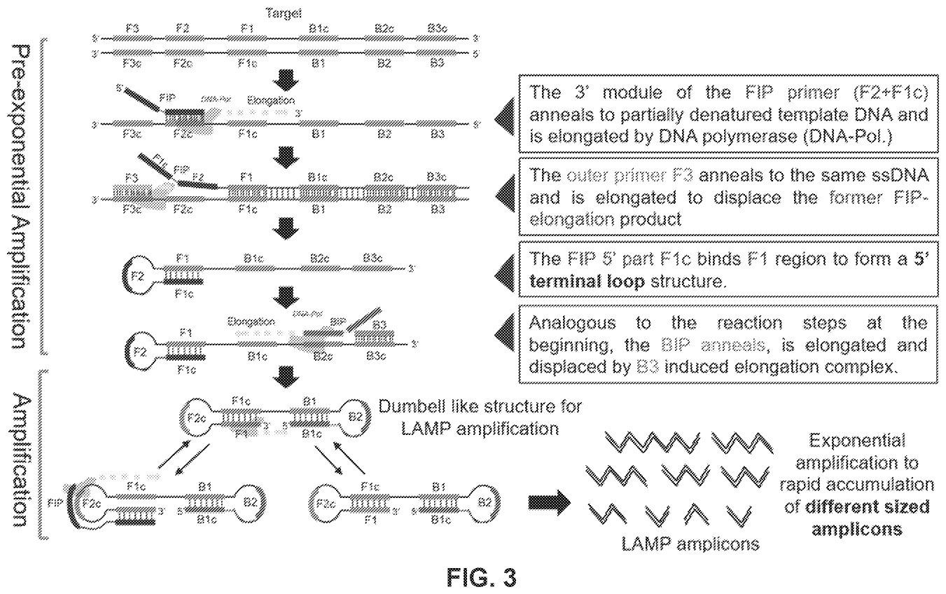

FIG. 3 is a diagram of an example working principle of LAP. In the example loop-mediated isothermal amplification of FIG. 3, the process includes a pre-exponential amplification process in which an FIP primer is annealed to a partially denatured template DNA. Then, further amplification occurs for rapid accumulation of different sized amplicons.

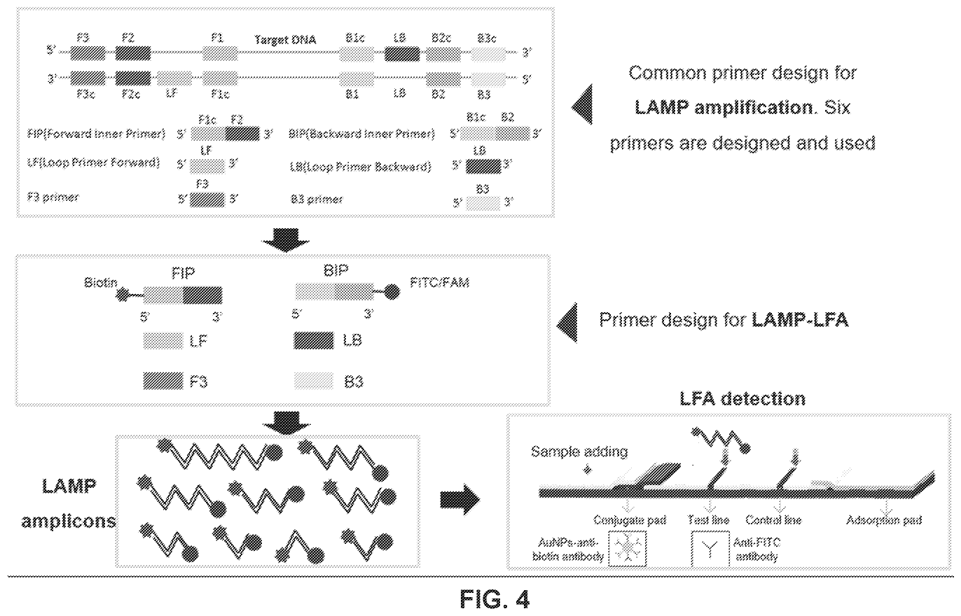

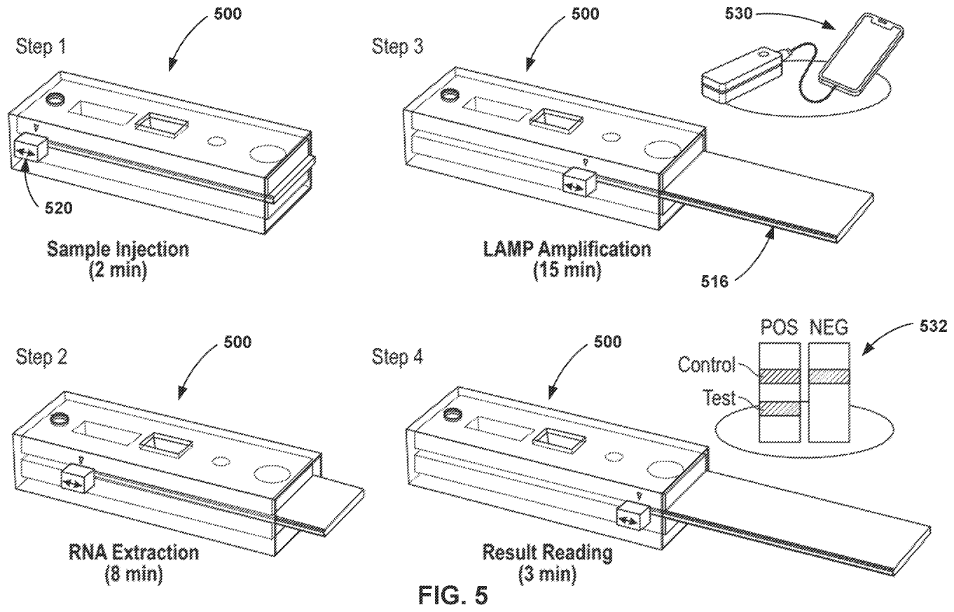

FIG. 4 is a flow chart illustrating a technique for LAMP-LFA amplification of DNA in a sample. In some examples, the designed primers can specifically identify the target sequence and then amplify with the aid of enzymes. The primers can have a significant impact on the sensitivity and specificity of the assay. To obtain better performance, several sets of primers can be designed targeting at the infectious pathogens. All primers can be examined by NCBI BLAST to confirm cross-reactivity before synthesis. Different sets of primers can be tested to investigate corresponding properties. The primers with best sensitivity and specificity can be used for any medical diagnostic devices described herein.

To visualize the isothermal application products, LFA is used. The Loop F/B primers are modified with Biotion and FITC respectively. After amplification, the target gene will form products carrying biotin and FITC. When the amplification product is dropped onto the LFA with the running buffer, the FITC modified on the product would bind to the gold-labeled anti-FITC antibody, and the biotin would be captured by streptavidin on the detection line of the strip, thus rendering color reaction. And the excess colloidal gold continues to flow to the control line, which combined with the secondary antibody to develop color reaction.

FIG. S is a diagram of a multistep process of using the example medical diagnostic device 100 of FIG. 1A. Medical diagnostic device 500 may be similar to medical diagnostic device 100. The steps of FIG. 5 may be completed using a heating element (such as heating elements 140 or 202) that draws power from a mobile device 530, for example. In step 1, the sliding plane 516 is positioned using knob 520 to receive the sample through the injection port. In step 2, the user slides the sliding plane 516 using knob 520 to the first chamber where the washing buffer is added to the sample and extract RNA from the sample. In step 3, the user moves the sliding plane 516 so that the sample chamber is positioned over the LAMP chamber and laser induced graphene heater 140. In this position, the device may undergo isothermal amplification, for example. Once this amplification step is complete, the user can, in the next step 4, move the sliding plane to the running buffer chamber as the final step to prepare the sample on the filter paper for viewing. In one example, the viewing window may be at this step four such that the filter paper 532 can be visible to the user. In other examples, the viewing window may be in the middle of the case such that the user can move the sliding panel back until the sample chamber and filter paper 532 therein can be visible through the viewing window at that location. In some examples, the filter paper 532 will include a control and test portion of the filter paper. The control color change indicates that the process was successful, and the test color change would only occur if the sample is positive for the biological substance between tested for, such as COVID-19.

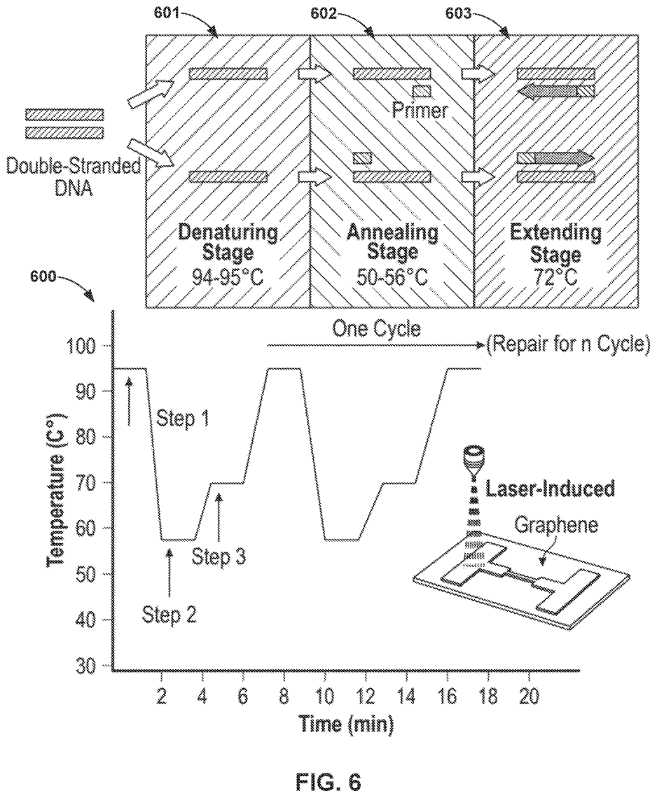

FIG. 6 is a graph 600 of example heating cycles using a heating element such as a laser induced graphene heater 202. PCR cycles can include multiple steps, such as step 1 (corresponding to stage 601), step 2 (corresponding to stage 602), and step 3 (corresponding to stage 603). These steps can be repeated over many cycles to amplify the quantity of DNA segments to detectable levels. A PCR cycle may include the denaturing stage at a temperature of 94-95 degrees Celsius, followed by an annealing stage of 50-56 degrees Celsius, which then is followed by an extending stage at approximately 72 degrees Celsius. A laser induced graphene heating element can achieve these heating cycles and cooling cycles within a desired timeframe. For example, shorter cycles can decrease the time needed to perform a PCR process. As shown in the example of FIG. 6, the entire three step cycle can be completed within seven minutes, but cycles may be achieved in shorter or longer times in other examples.

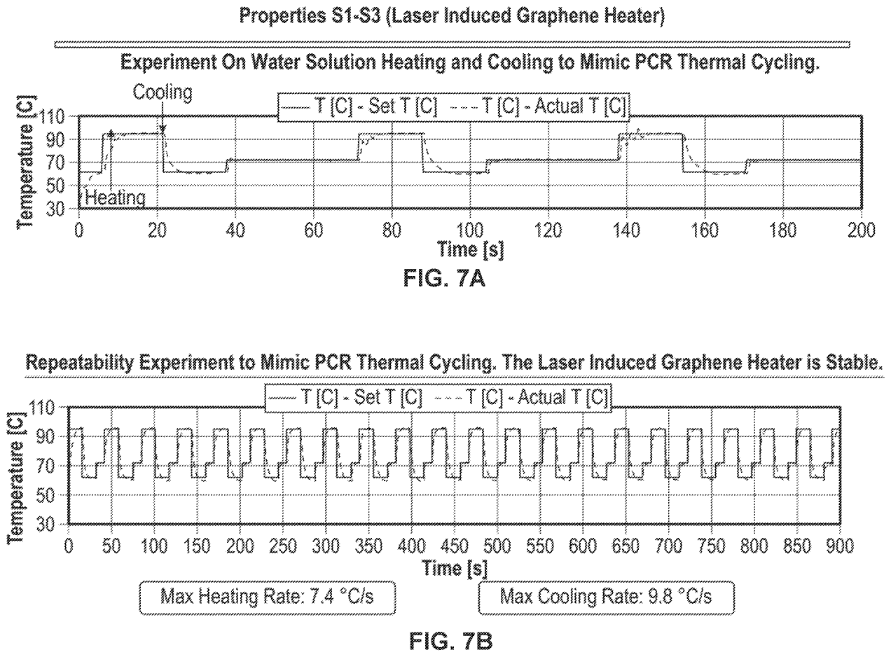

FIG. 7A is a graph of example heating and cooling using a laser induced graphene heating element. As shown, the actual temperature of the dotted line lags slightly behind the heating and cooling set temperatures of the solid line.

FIG. 7B is a graph of example heating and cooling cycles using a laser induced graphene heating element. The graph illustrates the repeatability of the beating and cooling performance of the laser induced graphene heating element. In this example heating element, a maximum heating rate of 7.4 degrees Celsius per second can be achieved, and a maximum cooling rate of 9.8 degrees Celsius per second can be achieved. Different heating and cooling rates may be achieved using different power levels applied to the heating element and/or different dimensions (e.g., volumes, surface area, etc.) of the heating element.

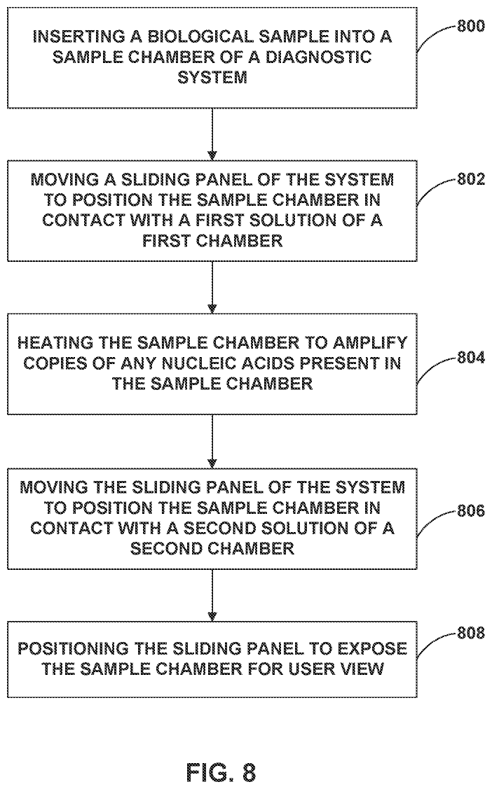

FIG. 8 is a flow diagram illustrating an example technique for operating a diagnostic system for analyzing a biological sample. The example of FIG. 8 is described with respect to medical diagnostic device 100, but other diagnostic devices or heating elements may be used in other examples (e.g., medical diagnostic device 500).

As shown in the example of FIG. 8, a user may insert a biological sample into a sample chamber of a diagnostic system, such as medical diagnostic device 100 (800). The sample chamber may be within a sliding panel, and the sample chamber may include filter paper to retain the sample provided by the user. Medical diagnostic device 100 may be pre-filled with appropriate solutions in each chamber of the device configured to detect the presence of a target biological substance, such as RNA from a virus.

The user can them move a sliding panel of medical diagnostic device 100 to position the sample chamber in contact with a first solution of a first chamber (802). For example the first solution may be a wash buffer that flows over the sample, or a PCR buffer if the wash buffer or equivalent has already been applied to the sample. The user can then initiate heating of the sample chamber to amplify copies of any nucleic acids present in the sample chamber (804). The heating may be performed using laser induced graphene heating element 140 carried within medical diagnostic device 100.

After the heating process is complete, the user can move the sliding panel of medical diagnostic device 100 to position the sample chamber in contact with a second solution in a second chamber (806). This second solution may be a running buffer or any other solution that is needed to be applied to the products of the amplification step. The user can then position the sliding panel to expose the sample chamber, and filter paper positioned therein, to be viewed through a viewing window of medical diagnostic device 200 (808).

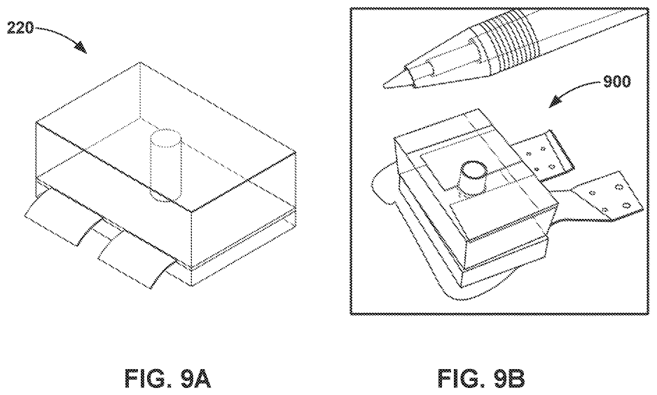

FIGS. 9A and 9B are conceptual illustrations of a laser induced graphene heating element, such as laser induced graphene heating element 140, that can be used in an induced graphene heating device 220. Device 900 is an image of a fabricated version of the conceptual device 220. Some graphene heaters sch as a graphene ink heater, can require fabrication times of more than 90 minutes due to ultra-sonification, UV curing, and drying of the graphene ink in that type of graphene heater. On the other hand, the a laser induced graphene heater as described herein can be fabricated in around 3 minutes or less for each heater. This short fabrication time can be due to high-speed CO2 laser writing and relatively simple device structure.

In some examples, graphene ink used to fabricate a graphene ink heater can cost from $54 to $122 per milliliter. In addition, graphene ink heaters require spin coating, heating, and drying before the device can be employed as heater. Conversely, a laser induced graphene heating element can be used as a heater immediately after CO2 laser writing, where the CO2 laser writing may be completed in about 10 seconds of operation or less, depending on the size of the laser induced graphene element. In some examples, CO2 laser writing on polyimide can generate the laser induced graphene layer used for the heater. In one example, polyimide tape having a size of ⅛″×36 yards can cost around $24.50, which is relatively inexpensive. For heaters the size needed for medical diagnostic device 100, such a size of polyimide tape can be used to fabricate over 160 laser induced graphene heating devices.

A laser induced graphene heating element can require substantially less power to heat than other graphene heaters. For example, a graphene ink heater may require 12.9 times the power needed for laser induced graphene heater 140 to achieve the operating temperature of 95 degrees Celsius as described for the PCR heating cycles described herein.

A laser induced graphene heater also requires fewer components than a graphene ink heater. For example, a graphene ink heater can be fabricated of cut-out polypropylene tube, copper tapes, silver paste, soda-lime glass, and cured graphene ink. In contrast, a laser induced graphene heating device can be fabricated out of PMMA (Poly (Methyl Methacrylate)) and polyimide tape, both of which can be laser cut.

A laser induced graphene heater may have additional properties. In some examples, the surface of the graphene ink heater includes a 4×4 hole array pattern, which can improve the heat distribution of the PCR reagent because of the hydrophobic surface. For the LIG heater, the PCR reagent would be in contact with the polyimide (PI) tape, which has a hydrophilic surface, so no hole array pattern is necessary.

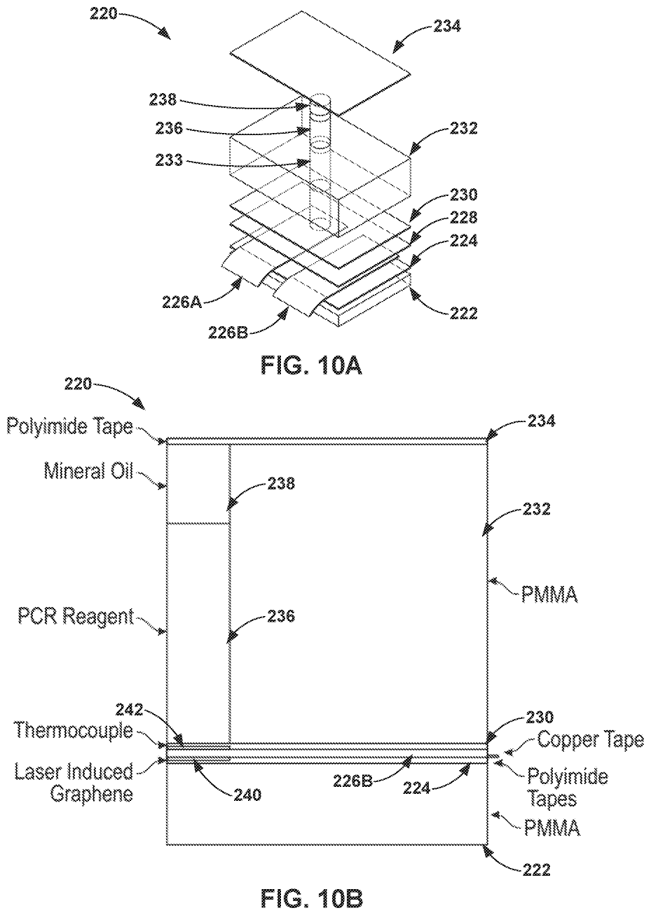

FIGS. 10A and 10B are an exploded view and cross-sectional view of an example graphene heating device 20 and example chamber to be beated. Graphene heating element 220 may be similar to a portion of medical diagnostic device 200 and/or heating element 202. As shown in the examples of FIGS. 10A and 10B, the layers and components of a laser induced graphene heating element 220 and corresponding heating structure can be fabricated quickly, such as less than 10 minutes or less than 3 minutes, with relatively simple assembly. In one example, all components of a laser induced graphene heating device can be assembled together by polyimide tape 224 and the majority of the components can be laser cut. In the example of FIG. 10A, the layers, from bottom to top, include PMMA layer 222, polyimide tape 224 (which can include graphene layer 240), copper tape 226A and 226B, polyimide tape 230, PMMA layer 232, and polyimide tape 234. PMMA layer 232 defines chamber 233 that is configured to retain substances, such as PCR reagent 236 and mineral oil 238. The heating element is not shown in FIG. 10B.

FIG. 10B illustrates an example cross section of the layers and components of a laser induced graphene heating device220. The base may be constructed of a layer of PMMA 222 with a layer of polyimide tape 224 on the PMMA layer 222. A CO2 laser may write on at least a portion, e.g., some of, or all of, the polyimide tape 224 to generate a laser induced graphene layer 240. One or more electrically conductive layers, such as a copper tape 226B, may be placed on top of and in contact with the laser induced graphene layer 240. A thermocouple 242 may be placed on top of the copper tape 226B, but may be placed in other locations of the device in other examples. Another layer of polyimide tape 230 may be placed over the copper tape 226B. A main PMMA layer 232 may be placed on top of the polyimide tape 230. The main PMMA layer 232 may create chambers (e.g., chamber 233 in FIG. 10A) that may be constructed to hold a fluid or other substance to the heated, such as a chamber for a PCR reagent 236 and/or a mineral oil layer 238 that may reduce evaporation of the PCR reagent 236. A layer of polyimide tape 234 may provide a final top layer to the device 220. This construction is just one example for a laser induced graphene heating device. Greater or fewer layers, and/or other materials, may be used in different examples.

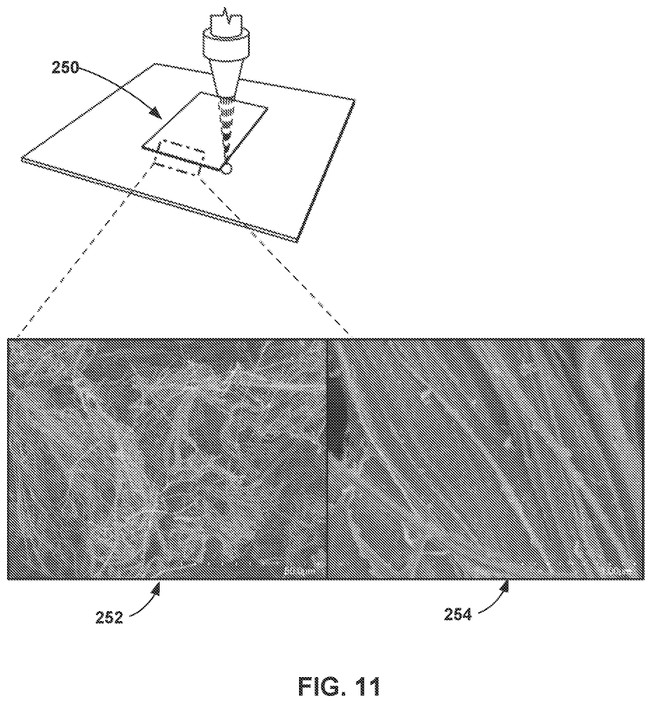

FIG. 11 includes different magnification images of a laser induced graphene layer 250 (which may be similar to graphene layer 240 of FIG. 10B) for a heating element, such as heating element 202. A laser induced graphene heating element can be generated by laser rastering using a 10.6 micrometer CO2 laser. Other CO2 lasers may be used in other examples. As shown in the left image 252 with the scale of 50 micrometers, the cross-section of the laser induced graphene element resembles a forest morphology. In some examples, the thickness of the laser induced graphene layer 250 may be less than 1 millimeter. In other examples, the thickness of the laser induced graphene layer may be less than 500 micrometers, or less than 300 micrometers. Individual filaments may be less than 100 nanometers, less than 50 nanometers, or even less than 30 nanometers. Image 254 shows a magnified view of a filament of graphene layer 250, with a scale of 1 micrometer.

One of the differences between a laser induced graphene layer 250 and spin coated graphene ink is the structure of the graphene. As opposed to the forest morphology of the laser induced graphene layer, cured graphene ink forms multilayer sheets that are generally parallel with the plane of the graphene layer. The forest morphology of the laser induced graphene layer can provide improved heating performance compared to graphene ink, such as more efficient beat generation from the same power input (e.g., increased heating with less electrical power) and increased heating and cooling rates.

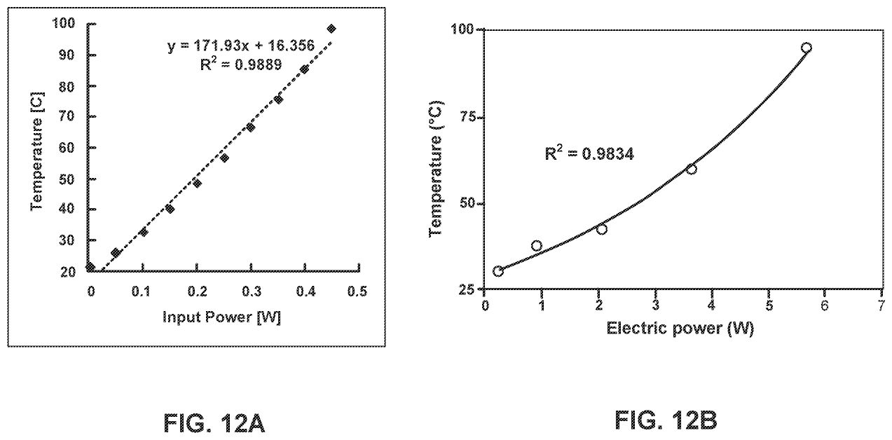

FIG. 12A is a graph of temperate for different input power for a laser induced graphene heating element (e.g., laser induced graphene heater 140), and FIG. 12B is a graph of temperate for different input power for a graphene ink heating element. As described herein, an example laser induced graphene heater can be constructed for relatively little power consumption. In one example, the laser induced graphene heating element can achieve and maintain 95 degrees Celsius with only about 0.45 Watts of input power. At only 5 volts, the laser induced graphene heater can reach temperatures more than 81 degrees Celsius. At these power levels, a laser induced graphene heater can be powered using small portable batteries or even the battery of a smartphone. FIG. 12A illustrates that the steady-state temperature achievable by the laser induced graphene heating element at different input powers. The relationship between input power and temperature is relatively linear, which can improve control accuracy.

In contrast, a graphene ink heater can require 5.8 Watts to achieve 95 degrees Celsius, which is about 12.9 times the power required for a laser induced graphene heater. At only 5 volts, a graphene ink heater may only achieve 30.6 degrees Celsius, which is more than 50 degrees less than what the laser induced graphene heater can achieve. FIG. 12B illustrates the steady-state temperature achievable by the graphene ink heater at different input powers, which indicates an generally exponential relationship between input power and resulting temperature.

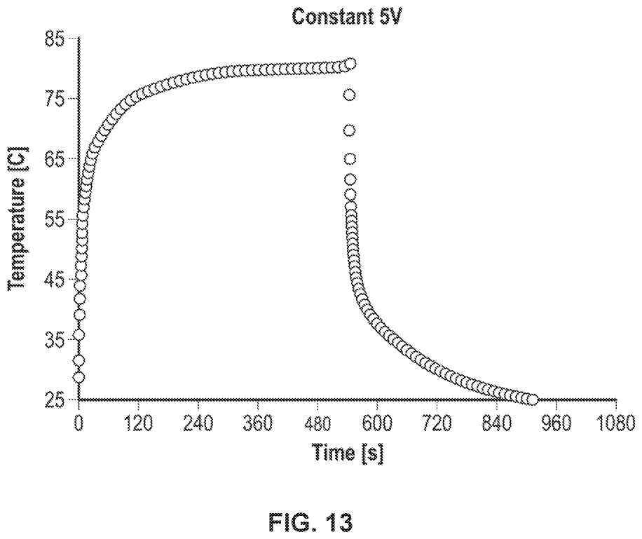

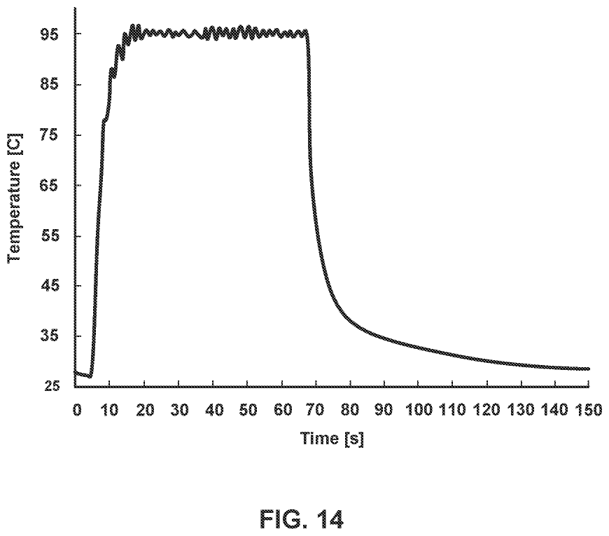

FIGS. 13 and 14 are graphs of temperature over time for an example graphene heating element. FIG. 13 indicates how the temperature of the laser induced graphene heating element changes over time due to a constant input of 5 volts. FIG. 14 indicates the temperature achievable using varied input power. In this manner, the laser induced graphene heating element described herein can achieve a maximum heating of about 11.1 degrees Celsius per second and cooling rate of about −13.7 degrees Celsius per second. These heating and cooling rates may be specific to one example described herein. Other heating and cooling rates may change due to the thickness and/or surface area of the laser induced graphene heating element. In addition, heating rates may be subject to the provided input power.

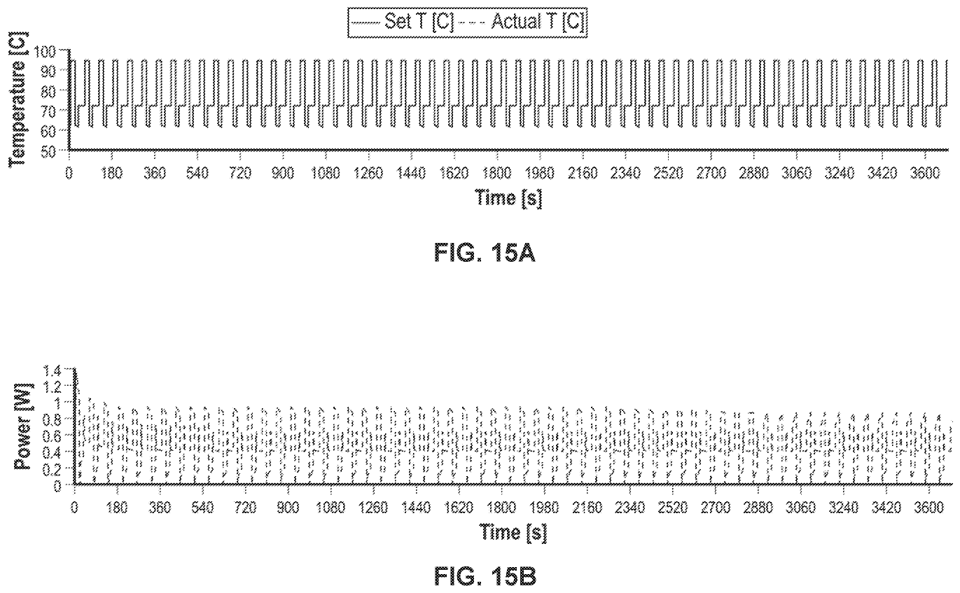

FIG. 15A is a graph of temperature over time for a graphene heating element (e.g., laser induced graphene heater 140) cycling temperature for one-minute PCR cycles. FIG. 15BA is a graph of power required over time to achieve the cycling temperature for one-minute PCR cycles in FIG. 15A.

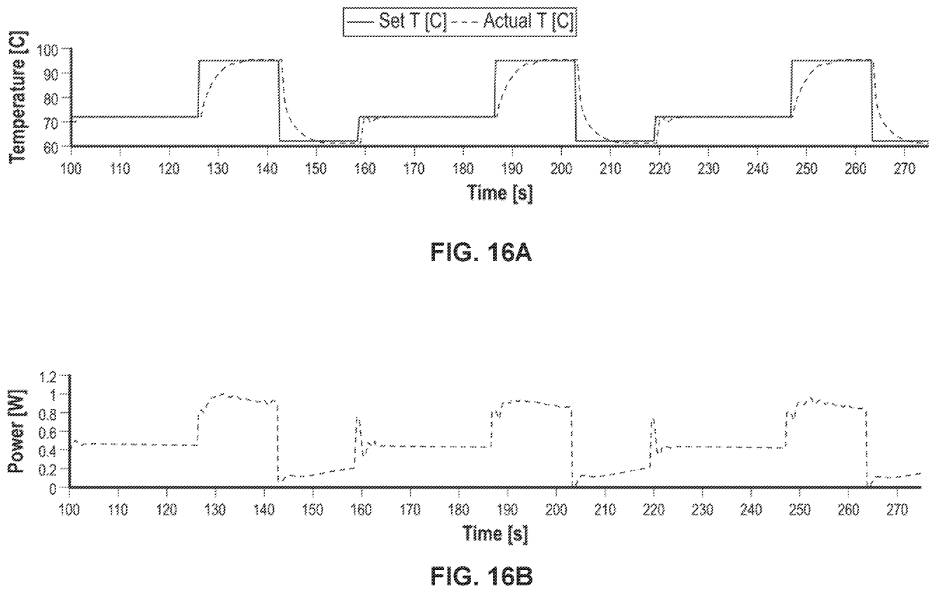

FIGS. 16A and 16B are graphs of temperature and power over time for a graphene heating element (e.g., laser induced graphene heater 140) during cycling. FIGS. 16A and 16B provided a detailed view of graphs 15A and 15B, respectively. As seen in FIG. 16A, the set or requested temperature for the laser induced graphene heater is generally a square wave. Since the temperature cannot be increased in such a stepwise manner, the actual temperature of the laser induced graphene heater lags slightly behind in both heating and cooling. However, temperature increases from approximately 71 degrees Celsius to 95 degrees Celsius in less than 10 seconds. Cooling rates are faster, such as 95 degrees Celsius to 62 degrees Celsius in less than 8 seconds.

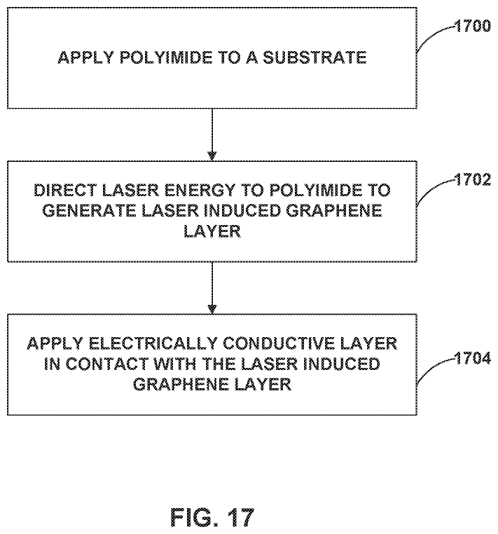

FIG. 17 is an example process for manufacturing a laser induced graphene heater as described herein. In the example of FIG. 17, a laser induced graphene heater, such as laser induced graphene heater 140, can be fabricated using laser rastering of polyimide. Polyimide, such as a polyimide tape, can be applied to a substrate, such as PMMA (1700). Then, laser energy can be directed to the polyimide to generate a laser induced graphene layer in the polyimide on the substrate (1702). A CO2 laser may be used for this process in one example. The laser can be moved in a variety of patterns across the polyimide to generate the size and shape of graphene as desired. After the graphene layer is generated, an electrically conductive layer can be applied to be in contact with the laser induced graphene layer (1704). An electrically conductive layer may be configured to be coupled to a power source to as to transfer power from the power source and to the graphene layer such that resistive heating can occur. In one example, the electrically conductive layer can be copper, a copper tape, or any other electrically conductive material.

FIG. 18A is an exploded view of an example medical diagnostic device 1800 that includes a heating element 1804 as described herein. FIG. 18B is a perspective view of medical diagnostic device 1800 of FIG. 18A. Medical diagnostic device 1800 may be used as an on chip LAMP device with graphene heating element 1804 that supports the addition and extraction of a sample solution 1822. Medical diagnostic device 1800 may be similar to Medical diagnostic device 100 or 500 described herein, but constructed in a different manner.

As shown in the example of FIG. 18A, medical diagnostic device 1800 includes substrate 1802, middle layer 1806, and top layer 1808. Substrate layer 1802 may be polyimide (e.g., polyimide tape), a polymer (e.g., PMMA) comprising polyimide, or some other structure. Heating element 1804, such as a laser induced graphene heater, may be disposed on substrate 1802. The shape of heating element 1804 may be of any desired shape, and may be configured to be disposed under a portion or a complete length of microfluidic channel 1810 formed by middle layer 1806, substrate 1802, and top layer 1808. In some examples, heating element 1804 may come in direct contact with fluid in microfluidic channel 1810 or be separated from the channel via another layer of material.

Middle layer 1806 may be formed with a central void that may correspond to at least a portion of microfluidic channel 1810. In some example, middle layer 1806 may be an ultraviolet (UV) curing glue, other adhesive, or a polymer. Top layer 1808 may enclose at least a portion of the top of microfluidic channel 1810 by being disposed on top of middle layer 1806. Top layer 1808 may be one or more glass slides, one or more polymer structures, or any other material. Top layer 1808 may also define inlet opening 1812 and outlet opening 1814 that are both in fluid communication with microfluidic channel 1810. In some examples, medical diagnostic device 1800 may also include an electrically conductive layer disposed in contact with heating element 1804, wherein the electrically conductive layer is configured to be coupled to a power source.

In some examples, medical diagnostic device 1800 may be an example of an on-chip device utilizing a laser induced graphene heater configured for LAMP amplification. This design employs one or more microfluidic channels as reaction chambers for LAMP reactions, wherein the microfluidic channels (e.g., microfluidic channel 1810) has a relatively short height, or distance, between substrate 1802 and top layer 1808. This low height can reduce temperature non-uniformity that could occur with larger height of fluid moving through a channel having a larger height. The microfluidic channels can include one or more inlet and one or more outlet for convenient addition or extraction of solutions from both sides. A laser-induced graphene heater (e.g., beating element 1804) can be positioned on the backside of the reaction chambers (e.g., microfluidic channel 1810) as the heating element.

As shown in the example of FIG. 18B, a pipette containing a sample 1822 can inject sample 1822 into an inlet (e.g., inlet opening, 1812) to force sample 1822 through microfluidic channel 1810. Once the volume of microfluidic channel 1810 is filled with sample 1822, sample 1822 fluid will exit out of outlet opening 1814.

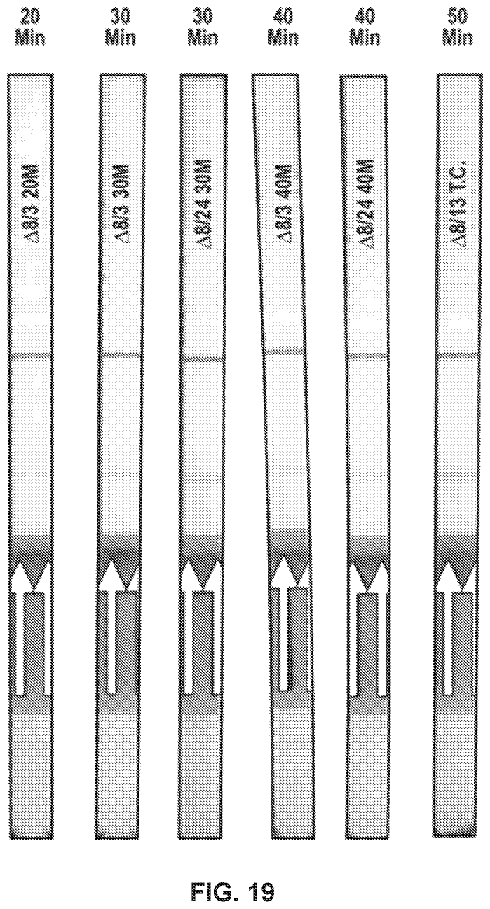

FIG. 19 is an illustration of example test strips for different samples using the medical diagnostic device of FIGS. 18A and 18B. The test strips are illustrative of test results of DNA amplification at different replication times in the LFA with medical diagnostic device 1800 (e.g., an on chip LAMP device). Clear positive test lines are visible in all samples with replication times exceeding 20 minutes, indicating successful amplification and detection of DNA. Shorter or longer replication times may be used in other examples. In some examples, a replication time of 30 minutes may be used in order to meet target amplification depending on the conditions of the sample within medical diagnostic device 1800.

The following examples are described herein.
Example 1. A heating device, the device comprising: a substrate; a laser induced graphene layer disposed on the substrate; and an electrically conductive layer disposed in contact with the laser induced graphene later, wherein the electrically conductive layer is configured to be coupled to a power source.
Example 2. The heating device of example 1, wherein the substrate comprises polyimide.
Example 3. The heating device of example 2, wherein the laser induced graphene is formed in at least a portion of the polyimide.
Example 4. The heating device of example 1, wherein the substrate comprises polyimide tape.
Example 5. The heating device of any of examples 1 through 4, wherein the laser induced graphene layer comprises graphene filaments arranged in a first direction generally orthogonal to a second direction of a plane of the laser induced graphene layer.
Example 6. The heating device of any of examples 1 through 5, wherein the laser induced graphene layer comprises a thickness less than 1 millimeter.
Example 7. The heating device of example 6, wherein the thickness is less than 500 micrometers.
Example 8. The heating device of any of examples 1 through 7, wherein the substrate comprises a polymer.
Example 9. The heating device of example 8, wherein the substrate comprises poly methyl methacrylate (PMMA).
Example 10. The heating device of any of examples 1 through 9, wherein the electrically conductive layer comprises a copper tape
Example 11. The heating device of any of examples 1 through 10, further comprising the power supply, a controller, and a temperature sensor, wherein the controller is configured to control power from the power supply to the electrically conductive layer based on a signal from the temperature sensor.
Example 12. The heating device of any of examples 1 through 11, further comprising: a middle layer on the substrate, the middle layer forming a central void over at least a portion of the laser induced graphene layer; and a top layer over the middle layer, wherein the substrate, the middle layer, and the top layer defines a microfluidic channel comprising the central void.
Example 13. The heating device of example 12, wherein the middle layer comprises an ultraviolet curing glue, and wherein the top layer comprises at least one glass slide.
Example 14. The heating device of example 13, wherein the top layer defines an inlet opening in fluid communication with the microfluidic channel and an outlet opening in fluid communication with the microfluidic channel.
Example 15. A method of manufacturing the heating device of any of examples 1through 14, wherein the method comprises: applying polyimide to the substrate; directing laser energy to the polyimide to generate the laser induced graphene layer in the polyimide on the substrate; and applying the electrically conductive layer in contact with the laser induced graphene layer.
Example 16. A method of manufacturing a laser induced graphene heating device, wherein the method comprises: applying polyimide to a substrate; directing laser energy to the polyimide to generate a laser induced graphene layer in the polyimide on the substrate; and applying an electrically conductive layer in contact with the laser induced graphene layer, wherein the electrically conductive layer is configured to be coupled to a power source.
Example 17. The method of example 16, further comprising forming a microfluidic channel by: applying a layer of ultraviolet curing glue to a portion of the polyimide to form a central void over at least a portion of the laser induced graphene layer, the layer of ultraviolet curing glue forming a side wall around the central void that is part of the microfluidic channel; and applying a glass layer onto the layer of ultraviolet curing glue to form a top of the microfluidic channel, the glass layer defining an inlet opening to the microfluidic channel and an outlet opening to the microfluidic channel, wherein the microfluidic channel is in thermal contact with the laser induced graphene layer.
Example 18. An on-chip diagnostic system, the system comprising: a substrate; a laser induced graphene layer disposed on the substrate; a middle layer on the substrate, the middle layer forming a central void over at least a portion of the laser induced graphene layer; and a top layer over the middle layer, wherein the substrate, the middle layer, and the top layer defines a microfluidic channel comprising the central void.
Example 19. The system of example 18, wherein the middle layer comprises an ultraviolet curing glue, and wherein the top layer comprises at least one glass slide.
Example 20. The system of example 19, wherein the top layer defines an inlet opening in fluid communication with the microfluidic channel and an outlet opening in fluid communication with the microfluidic channel.
Example 21. The system of any of examples 17 through 20, further comprising an electrically conductive layer disposed in contact with the laser induced graphene layer, wherein the electrically conductive layer is configured to be coupled to a power source.
Example 22. The system of any of examples 17 through 21, wherein the substrate comprises polyimide.
Example 23. The system of any of examples 17 through 22, wherein the laser induced graphene is formed in at least a portion of the polyimide.
Example 24. The system of any of examples 17 through 23, wherein the substrate comprises polyimide tape
Example 25. The system of any of examples any of examples 17 through 24, wherein the laser induced graphene layer comprises graphene filaments arranged in a first direction generally orthogonal to a second direction of a plane of the laser induced graphene layer.
Example 26. The system of any of examples 17 through 25, wherein the laser induced graphene layer comprises a thickness less than 1 millimeter.
Example 27. The system of example 26, wherein the thickness is less than 500 micrometers.
Example 28. The system of any of examples 17 through 27, wherein the substrate comprises a polymer.
Example 29. The system of example 28, wherein the substrate comprises poly methyl methacrylate (PMMA).
Example 30. The system of example 21, wherein the electrically conductive layer comprises a copper tape.
Example 31. The system of any of examples 17 through 30, further comprising the power supply, a controller, and a temperature sensor, wherein the controller is configured to control power from the power supply to an electrically conductive layer in contact with the laser induced graphene layer based on a signal from the temperature sensor.
Example 32. A diagnostic system, the system comprising: a first housing portion defining: an injection port; a first chamber configured to contain a first solution; a second chamber configured to contain a second solution; a second housing portion defining at least one waste chamber configured to receive fluid from at least one of the first chamber or the second chamber; a graphene heating element carried on the second housing portion, wherein the graphene heating element comprises a laser induced graphene layer and an electrically conductive layer in contact with the laser induced graphene layer, wherein the electrically conductive layer is configured to be coupled to a power source; and a sliding panel comprising a sample chamber configured to contain a biological sample, wherein the sliding panel is: positioned between the first housing portion and the second housing portion; and configured to move the sample chamber to different positions corresponding to at least the first chamber and the second chamber of the first housing portion.

In one or more examples, the functions described herein, such as heating control of a heating element or control via a mobile device, may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather. as described above, various units may be combined in a hardware unit or provided by a collection of interoperative hardware units, including one or more processors as described above, in conjunction with suitable software and/or firmware.

1. A heating device comprising:
a substrate;
a laser induced graphene layer disposed on the substrate; and
an electrically conductive layer disposed in contact with the laser induced graphene layer, wherein the electrically conductive layer is configured to be coupled to a power source.

2. The heating device of claim 1, wherein the substrate comprises polyimide.

3. The heating device of claim 2, wherein the laser induced graphene layer is formed in at least a portion of the polyimide.

4. The heating device of claim 1, wherein the substrate comprises polyimide tape.

5. The heating device of claim 1, wherein the laser induced graphene layer comprises graphene filaments arranged in a first direction generally orthogonal to a second direction of a plane of the laser induced graphene layer.

6. The heating device of claim 1, wherein the laser induced graphene layer comprises a thickness less than 1 millimeter.

7. The heating device of claim 6, wherein the thickness is less than 500 micrometers.

8. The heating device of claim 1, wherein the substrate comprises a polymer.

9. The heating device of claim 8, wherein the substrate comprises poly methyl methacrylate (PMMA).

10. The heating device of claim 1, wherein the electrically conductive layer comprises a copper tape.

11. The heating device of claim 1, further comprising the power source, a controller, and a temperature sensor, wherein the controller is configured to control power from the power supply source to the electrically conductive layer based on a signal from the temperature sensor.

12. The heating device of claim 1, further comprising:
a middle layer on the substrate, the middle layer forming a central void over at least a portion of the laser induced graphene layer; and
a top layer over the middle layer, wherein the substrate, the middle layer, and the top layer define a microfluidic channel comprising the central void.

13. The heating device of claim 12, wherein the middle layer comprises an ultraviolet curing glue, and wherein the top layer comprises at least one glass slide.

14. The heating device of claim 13, wherein the top layer defines an inlet opening in fluid communication with the microfluidic channel and an outlet opening in fluid communication with the microfluidic channel.

15. (canceled)

16. A method of manufacturing a laser induced graphene heating device, wherein the method comprises:
applying polyimide to a substrate;
directing laser energy to the polyimide to generate a laser induced graphene layer in the polyimide on the substrate; and
applying an electrically conductive layer in contact with the laser induced graphene layer, wherein the electrically conductive layer is configured to be coupled to a power source.

17. The method of claim 16, further comprising forming a microfluidic channel by:
applying a layer of an ultraviolet curing glue to a portion of the polyimide to form a central void over at least a portion of the laser induced graphene layer, the layer of the ultraviolet curing glue forming a side wall around the central void that is part of the microfluidic channel; and
applying a glass layer onto the layer of the ultraviolet curing glue to form a top of the microfluidic channel, the glass layer defining an inlet opening to the microfluidic channel and an outlet opening to the microfluidic channel, wherein the microfluidic channel is in thermal contact with the laser induced graphene layer.

18. The method of claim 16, wherein the substrate comprises polyimide.

19. The method of claim 16, wherein the substrate comprises a polymer.

20. The method of claim 16, wherein the laser induced graphene layer comprises graphene filaments arranged in a first direction generally orthogonal to a second direction of a plane of the laser induced graphene layer.

21. A diagnostic system comprising:
a first housing portion defining:
an injection port;
a first chamber configured to contain a first solution; and
a second chamber configured to contain a second solution;
a second housing portion defining at least one waste chamber configured to receive fluid from at least one of the first chamber or the second chamber;
a graphene heating element carried on the second housing portion, wherein the graphene heating element comprises a laser induced graphene layer and an electrically conductive layer in contact with the laser induced graphene layer, wherein the electrically conductive layer is configured to be coupled to a power source; and
a sliding panel comprising a sample chamber configured to contain a biological sample, wherein the sliding panel is:
positioned between the first housing portion and the second housing portion; and
configured to move the sample chamber to different positions corresponding to at least the first chamber and the second chamber of the first housing portion.
